(19) United States
(12) Patent Application Publication
(10) Pub. No.: US 2026/0252989 A1
(43) Pub. Date: Aug. 27, 2026

(54) DEMAND RESOURCE MANAGEMENT SYSTEM THROUGH MULTI-ENERGY NETWORKS

(71) Applicant: ELECTRONICS AND TELECOMMUNICATIONS RESEARCH INSTITUTE, Daejeon (KR)

(72) Inventors: Hoon JEONG, Daejeon (KR); Tae-Wook HEO, Daegu (KR); IL Woo LEE, Daejeon (KR)

(21) Appl. No.: 19/545,256

(22) Filed: Feb. 20, 2026

(30) Foreign Application Priority Data
Feb. 21, 2025 (KR) 10-2025-0023007

(51) Int. Cl. G06Q 10/0631; G06Q 50/06

(52) U.S. Cl. CPC G06Q 10/06315; G06Q 50/06

(57) ABSTRACT

A demand resource management system through a multi-energy network includes: a main plant including one or more energy production units each configured to produce at least one energy selected from a group consisting of hot water, steam, cold energy, and compressed air; piping connecting each of the one or more energy production units and each of a plurality of demand sites to deliver the at least one energy produced in each of the one or more energy production units to each of the plurality of demand sites; and a management server configured to control the one or more energy production units and the piping so that energy corresponding to a type and an demand amount requested by each of the plurality of demand sites is supplied to the corresponding demand site.

### CROSS-REFERENCE TO RELATED APPLICATION

This application claims the benefit of Korean Patent Application No. 10-2025-0023007, filed on February 21, 2025, in the Korean Intellectual Property Office, the entire disclosure of which is incorporated herein by reference for all purposes.

### TECHNICAL FIELD

The present disclosure relates to a demand resource management system through a multi-energy network.

### BACKGROUND

Due to the increase in electronic devices, power consumption is increasing, and the demand for power generation is increasing. However, because it is impossible to increase the number of power plants indefinitely, infrastructure is being established to strengthen demand management that reduces power demand through proactive demand management for parts with high power consumption. For example, DR (Demand Response) is being used to prevent accidents due to power shortages and to reduce the cost of building additional power plants. Such power demand management focuses on stabilizing power demand and aims to reduce power usage during periods of surging power demand.

Meanwhile, recently, approaches and research for promoting networking have been pursued not only for electricity but also for various energies consumed in an industrial complex.

The background art of the present disclosure is disclosed in Korean Patent Application Publication No. 10-2016-0115102 (Published on Oct. 06, 2016).

### SUMMARY

A technical problem to be solved by the present disclosure is to provide a demand resource management system through a multi-energy network for networking energy sources used in an industrial complex and improving energy efficiency through demand management of the networked energy sources.

In accordance with a first aspect of the present disclosure, there is provided a demand resource management system through a multi-energy network, including: a main plant including one or more energy production units each configured to produce at least one energy selected from a group essentially consisting of hot water, steam, cold energy, and compressed air; piping connecting each of the one or more energy production units and each of a plurality of demand sites to deliver the at least one energy produced in each of the one or more energy production units to each of the plurality of demand sites; and a management server configured to control the one or more energy production units and the piping so that energy corresponding to a type and an demand amount requested by each of the plurality of demand sites is supplied to the corresponding demand site.

Further, the one or more energy production units may include: a hot water production unit for producing the hot water; a steam production unit for producing the steam; a cold energy production unit for producing the cold energy; and a compressed air production unit for producing the compressed air.

Further, the piping may include: hot water piping connecting the hot water production unit to each of the plurality of demand sites, respectively; steam piping connecting the steam production unit to each of the plurality of demand sites, respectively; cold energy piping connecting the cold energy production unit to each of the plurality of demand sites, respectively; and compressed air piping connecting the compressed air production unit to each of the plurality of demand sites, respectively.

Further, the main plant may further include an energy storage system for storing electricity produced by renewable energy.

Further, the piping may further include power piping connecting the energy storage system to each of the plurality of demand sites, respectively, to supply the electricity stored in the energy storage system to each of the plurality of demand sites.

Further, the main plant may further include a thermoelectric generation unit converting surplus energy, from the energy produced by the one or more energy production units, not supplied to the plurality of demand sites into electrical energy and storing the electrical energy in the energy storage system.

Further, the main plant may further include a measuring device generating information about an amount of energy produced and an amount of energy supplied by each of the one or more energy production units and transmitting the information to the management server.

Further, the management server may be configured to control the one or more energy production units to produce energy corresponding to the type and the amount of demand requested by each of the plurality of demand sites.

Further, each of the plurality of demand sites, when a storage unit for storing the energy supplied through the piping is provided, may perform demand management to reduce the demand amount during a time interval when a demand for the energy exceeds a supply amount of the energy, and may perform the demand management to receive an additional supply of the energy by an amount corresponding to the reduced demand amount when the supply amount of the energy exceeds the demand amount of the energy.

Further, the demand site, when a storage unit for storing the energy supplied through the piping is not provided, may perform demand management to reduce the demand amount during a time interval when the demand amount of the energy exceeds a supply amount of the energy.

In accordance with a second aspect of the present disclosure, there is provided a demand resource management system through a multi-energy network, including: a main plant arranged to produce at least one energy selected from a group essentially consisting of hot water, steam, cold energy, and compressed air; a plurality of demand sites for receiving and consuming the at least one energy produced in the main plant; piping connecting each energy source and each of the plurality of demand sites to deliver the at least one energy produced in the main plant to each of the plurality of demand sites; and a management server configured to control the piping so that energy corresponding to a type and an amount of demand requested by each of the plurality of demand sites is supplied to the corresponding demand site.

Further, the main plant may include an energy production unit including at least one of a hot water production unit for producing the hot water; a steam production unit for producing the steam; and a cold energy production unit for producing the cold energy, and a compressed air production unit for producing the compressed air.

Further, the main plant may further include an energy storage system for storing electricity produced by renewable energy.

Further, the main plant may further include a thermoelectric generation unit for converting surplus energy, from the energy produced by the energy production unit, not supplied to the plurality of demand sites into electrical energy and storing the electrical energy in the energy storage system.

Further, the main plant may further include a measuring device for generating information about an amount of energy produced and an amount of energy supplied by the energy production unit and transmitting the information to the management server.

Further, the piping may include different piping installed according to a type of the energy produced by the energy production unit.

Further, the piping may include: hot water piping connecting the hot water production unit to each of the plurality of demand sites, respectively; steam piping connecting the steam production unit to each of the plurality of demand sites, respectively; cold energy piping connecting the cold energy production unit to each of the plurality of demand sites, respectively; and compressed air piping connecting the compressed air production unit to each of the plurality of demand sites, respectively.

Further, the plurality of demand sites may be configured to perform at least one of DR (Demand Response) and Plus DR based on a demand for the energy and a supply amount received through the piping.

Further, each of the plurality of demand sites, when a storage unit for storing the energy supplied through the piping is provided, may perform demand management to reduce the demand amount during a time interval when a demand for the energy exceeds a supply amount of the energy, and may perform the demand management to receive an additional supply of the energy by an amount corresponding to the reduced demand amount when the supply amount of the energy exceeds the demand amount of the energy.

According to one aspect of the present disclosure, an embodiment produces energy sources such as hot water, steam, and compressed air used in an industrial complex in one place and configures a network through piping (a pipeline), whereby energy may be shared through the piping, and thereby, the energy may be effectively provided to demand sites requiring the energy.

According to one aspect of the present disclosure, for energies such as hot water, steam, and compressed air, a storage space for the corresponding energy source may be established at a lower cost compared to electricity, and through this, by applying various types of demand management (e.g., DR, Plus DR), the efficiency of the energy may be improved, and at the same time, the maintenance and performance of the energy production units may be improved by inducing operation of the energy production units at an optimal operating point.

### BRIEF DESCRIPTION OF THE DRAWINGS

FIG. 1 is a diagram for describing a conventional demand resource management system for an industrial complex.

FIG. 2 is a diagram for describing a demand resource management system through a multi-energy network according to an embodiment of the present disclosure.

FIG. 3 is an exemplary diagram illustrating a supply amount and a demand amount for a specific energy resource according to the embodiment of the present disclosure.

FIG. 4 is an exemplary diagram for describing a method of satisfying the demand by increasing the supply for a time interval during which the demand exceeds the supply in FIG. 3.

FIG. 5 is an exemplary diagram for describing demand management applying a DR method for the time interval during which the demand exceeds the supply in FIG. 3.

FIG. 6 is an exemplary diagram for describing demand management applying a DR method and a Plus DR method according to the embodiment of the present disclosure.

FIG. 7 is a diagram for describing a demand resource management system through a multi-energy network according to another embodiment of the present disclosure.

FIG. 8 is a diagram for describing a demand resource management system through a multi-energy network according to yet another embodiment of the present disclosure.

### DETAILED DESCRIPTION

Hereinafter, an embodiment of a demand resource management system through a multi-energy network according to an embodiment of the present disclosure will be described.

In this process, the thickness of lines or the size of components illustrated in the drawings may be exaggerated for clarity and convenience of description. Furthermore, the terms described below are terms defined in consideration of functions in the present disclosure and may vary according to the intention or custom of a user or an operator. Therefore, the definition of these terms should be understood based on the contents of the entire specification.

Hereinafter, embodiments of the present disclosure will be described in detail with reference to the accompanying drawings so that a person having ordinary skill in the art to which the present disclosure pertains may easily carry out the embodiments. However, the present disclosure may be embodied in many different forms and is not limited to the embodiments set forth herein. Furthermore, in the drawings, portions irrelevant to the description have been omitted to clearly describe the present disclosure, and similar reference numerals have been attached to similar portions throughout the specification.

Throughout the specification, when a part "includes" a certain component, this means that other components may be further included rather than being excluded, unless specifically stated otherwise.

The implementations described herein may be implemented as, for example, a method or process, an apparatus, a software program, a data stream, or a signal. Even if discussed only in the context of a single form of implementation (e.g., discussed only as a method), the implementation of a feature being discussed may also be implemented in other forms (e.g., as an apparatus or a program). An apparatus may be implemented with appropriate hardware, software, firmware, and the like. A method may be implemented in an apparatus such as a processor, which generally refers to a processing device including, for example, a computer, a microprocessor, an integrated circuit, or a programmable logic device.

Recently, approaches and research for promoting networking have been pursued not only for electricity but also for various energies consumed in an industrial complex. Energy sources subject to networking promotion include refrigeration systems, steam systems, cold/hot water, and compressed air, movable through piping (a pipeline).

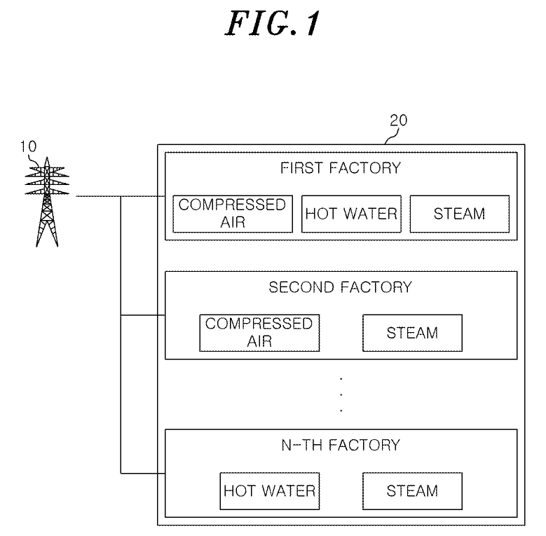

Factories 20 in a typical industrial complex, as illustrated in FIG. 1, receive electric power 10 and produce and use the hot water, steam, and compressed air energy required by the production process of the factory 20 by using separate fuel (LPG, LNG, kerosene, etc.) according to the process.

To this end, the factories 20 of the industrial complex possess energy production units (not shown) producing hot water, steam, and compressed air, and in many cases, possess energy production units of a higher specification than the specification required by the corresponding facility for stable operation of the energy production units. Furthermore, the energy production units do not operate continuously for 24 hours, and their use is determined according to the work schedule of the corresponding facility. As such, for the hot water, steam, and compressed air energy production units possessed by the industrial complex, operating them moderately rather than using them a little is advantageous for the maintenance and performance of the energy production units due to their optimal operating point.

Accordingly, the present disclosure proposes a technology for networking energy sources such as hot water, steam, and compressed air essentially used in most industrial complexes, and for improving energy efficiency through efficient demand management of multiple energy sources. An industrial complex may include a main plant and a plurality of demand sites. The main plant may refer to an industrial entity (factory) producing and supplying energy such as hot water, steam, cold energy, and compressed air. A demand site may refer to a factory, equipment, facility, etc., receiving and consuming energy supplied from the main plant.

The present disclosure allows for producing energy sources such as hot water, steam, and compressed air in one place and configuring a network through piping (a pipeline) to provide them to demand sites (factories) requiring the energy. At this time, the present disclosure allows for improving the efficiency of energy by applying various types of demand management (e.g., DR, Plus DR), and at the same time, for improving the maintenance and performance of energy production units by inducing their operation at an optimal operating point.

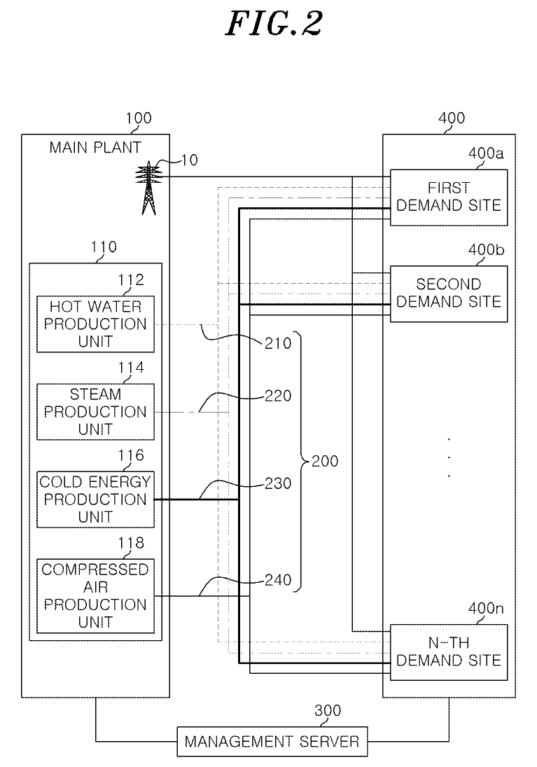

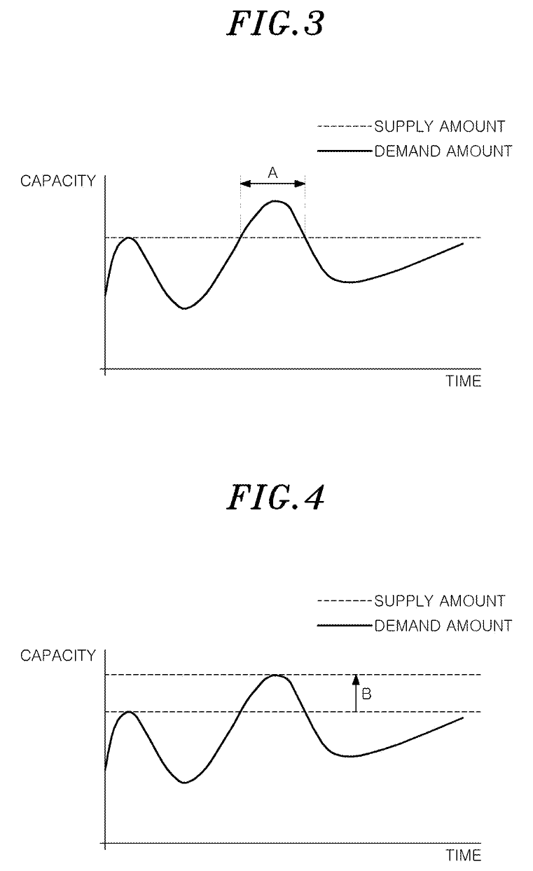

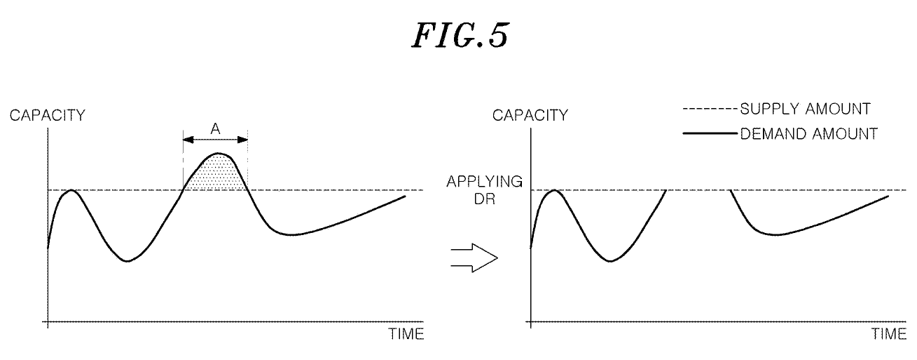

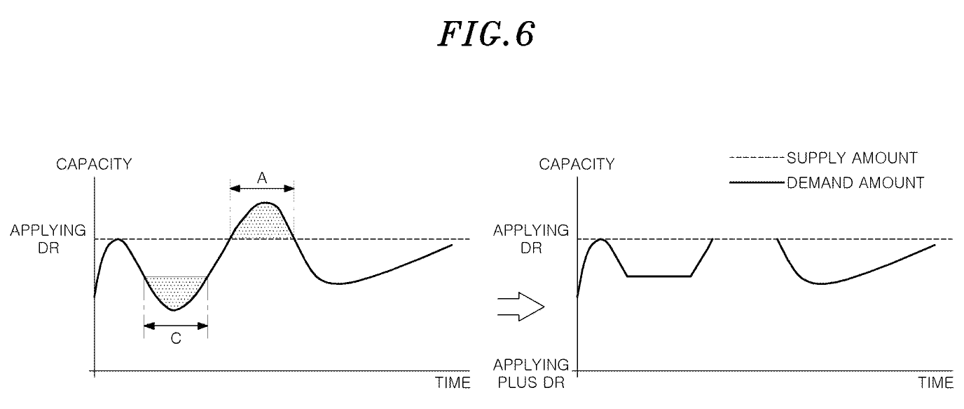

FIG. 2 is a diagram for describing a demand resource management system through a multi-energy network according to an embodiment of the present disclosure, FIG. 3 is an exemplary diagram illustrating a supply amount and a demand amount for a specific energy resource according to the embodiment of the present disclosure, FIG. 4 is an exemplary diagram for describing a method of satisfying the demand by increasing the supply for a time interval during which the demand exceeds the supply in FIG. 3, FIG. 5 is an exemplary diagram for describing demand management applying a DR method for a time interval during which the demand exceeds the supply in FIG. 3, and FIG. 6 is an exemplary diagram for describing demand management applying a DR method and a Plus DR method according to the embodiment of the present disclosure.

Referring to FIG. 2, a demand resource management system through a multi-energy network according to the embodiment of the present disclosure may include a main plant 100, piping 200, a management server 300, and demand sites 400a, 400b, ..., 400n (hereinafter, referred to as '400').

The main plant 100 may refer to an industrial entity (factory) that produces and supplies energy such as hot water, steam, cold energy, and compressed air.

The main plant 100 may include an energy production unit 110 producing at least one energy from among hot water, steam, cold energy, and compressed air.

The energy production unit 110 may supply the produced energy to the demand site 400 under the control of the management server 300.

The energy production unit 110 may include a hot water production unit 112 for producing hot water, a steam production unit 114 for producing steam, a cold energy production unit 116 for producing cold energy, and a compressed air production unit 118 for producing compressed air.

The hot water production unit 112 may produce and store hot water using a heat exchanger or the like.

The steam production unit 114 may produce and store steam using a steam boiler, a heat exchanger for steam generation, a supply heat medium, or the like.

The cold energy production unit 116 may produce and store cold energy using a vapor-compression refrigerator, an absorption refrigerator, or the like.

The compressed air production unit 118 may produce and store compressed air using a compressor or the like.

The energy production unit 110 may be connected to the demand site 400 through the piping 200 to trade energy, and the piping 200 may be installed to match the type of energy being traded.

Meanwhile, a measuring device (not shown) for measuring the energy produced and supplied from each energy production unit 110 for each type of energy may be installed in the main plant 100, and the measured information may be transmitted to the management server 300. The main plant 100 may generate information about the amount of energy produced and supplied for each energy type, and may transmit the generated information to the management server 300.

The piping 200 may connect each energy production unit 110 and each demand site 400 to deliver the energy produced in each energy production unit 110 to each of the plurality of demand sites 400.

The piping 200 may include hot water piping 210, steam piping 220, cold energy piping 230, and compressed air piping 240.

The hot water piping 210 may connect the hot water production unit 112 to each demand site 400, respectively.

For example, when the demand site 400 includes a first demand site 400a to a third demand site 400c, the hot water piping 210 may connect the hot water production unit 112 and the first demand site 400a, connect the hot water production unit 112 and the second demand site 400b, and connect the hot water production unit 112 and the third demand site 400c.

The hot water piping 210 may be implemented with a material having excellent heat resistance and corrosion resistance. For example, the hot water piping 210 may be implemented with copper pipe, PB (polybutylene) pipe, stainless steel, or the like.

The steam piping 220 may connect the steam production unit to each demand site 400, respectively.

For example, when the demand site 400 includes a first demand site 400a to a third demand site 400c, the steam piping 220 may connect the steam production unit 114 and the first demand site 400a, connect the steam production unit 114 and the second demand site 400b, and connect the steam production unit 114 and the third demand site 400c.

The steam piping 220 may be implemented with a material suitable for withstanding high temperature and high pressure. For example, the steam piping 220 may be implemented with steel pipe, alloy steel pipe, or the like.

The cold energy piping 230 may connect the cold energy production unit 116 to each demand site 400, respectively.

For example, when the demand site 400 includes a first demand site 400a to a third demand site 400c, the cold energy piping 230 may connect the cold energy production unit 116 and the first demand site 400a, connect the cold energy production unit 116 and the second demand site 400b, and connect the cold energy production unit 116 and the third demand site 400c.

The cold energy piping 230 may be implemented with a material suitable for minimizing heat loss. For example, the cold energy piping 230 may be implemented with pre-insulated pipe, PVC, or the like.

The compressed air piping 240 may connect the compressed air production unit 118 to each demand site 400, respectively.

For example, when the demand site 400 includes a first demand site 400a to a third demand site 400c, the compressed air piping 240 may connect the compressed air production unit 118 and the first demand site 400a, connect the compressed air production unit 118 and the second demand site 400b, and connect the compressed air production unit 118 and the third demand site 400c.

The compressed air piping 240 may be implemented with a material having excellent pressure resistance. For example, the compressed air piping 240 may be implemented with metal pipes such as iron, aluminum, and copper pipes, or non-metal pipes such as urethane, nylon, and Teflon.

The management server 300 may control the energy produced and traded at the energy production unit 110 and the demand site 400 and monitor transaction information, thereby enabling integrated management and control.

The management server 300 may control the energy production unit 110 to produce energy corresponding to the type and amount of demand requested by each demand site 400.

The management server 300 may control the corresponding energy production unit 110 and the corresponding piping 200 so that energy corresponding to the type and amount of demand requested by each demand site 400 is supplied to the respective demand site 400.

The demand site 400 may refer to a factory, equipment, facility, etc., that receives and consumes energy supplied from the energy production unit 110. The demand site 400 may determine both the type of energy and the amount of demand to be received from the main plant 100, and may change them.

The demand site 400 may be connected to the energy production unit 110 through the piping 200.

The demand site 400 may operate facilities by receiving energy from the energy production unit 110.

A measuring device (not shown) for measuring the energy consumed at the demand site 400 for each type of energy may be installed at the demand site 400.

The demand site 400 may consume various energies such as hot water, steam, and compressed air by applying various types of demand management (e.g., DR, Plus DR). That is, the demand site 400 may apply demand management to reduce the demand during a time interval when the energy demand exceeds the energy supply (DR), and to receive an additional energy supply equivalent to the reduced demand amount when the energy supply exceeds the energy demand.

The DR (Demand Response) method may be a method of reducing demand during time intervals when energy demand exceeds energy supply through demand reduction without facility expansion. DR may be a mechanism for maintaining the stability of the energy system and reducing costs by adjusting energy demand. DR may reduce demand when energy demand is high. DR may be used mainly during peak hours of high energy demand or in situations where energy supply is insufficient.

Plus DR may be increasing demand when energy supply is greater than demand. Plus DR may be applied in situations where renewable energy output control is necessary, that is, when energy supply exceeds demand. Plus DR may be a method of receiving an additional energy supply, equivalent to a previously curtailed amount, when the energy supply exceeds the energy demand.

Meanwhile, for the energy production unit 110, supplying a constant amount of energy to the demand site 400 may be advantageous for energy consumption or maintenance of the energy production unit 110. That is, for the energy production unit 110, providing energy with a constant supply amount that does not have a large fluctuation range may be advantageous for energy consumption or maintenance of the energy production unit 110. Furthermore, energies such as steam, hot water, and compressed air do not require expensive facilities for storage, and the cost does not increase proportionally as the capacity increases. Furthermore, since energies such as steam, hot water, and compressed air are easy to store not only at the production site but also at the consumption site, it is very advantageous to apply Plus DR, which is used in power demand management.

Therefore, the demand site 400 may consume various energies such as hot water, steam, and compressed air by applying at least one of DR and Plus DR.

For example, an energy resource having the relationship between supply and demand as illustrated in FIG. 3 will be described. Referring to FIG. 3, it may be confirmed that the supply of the energy resource is higher than the demand across all time periods, but in time period A, the demand exceeds the supply. In such a case, as illustrated in FIG. 4, the demand may be satisfied by increasing the supply by B. However, this requires facility expansion to increase the supply, which has a disadvantage of requiring a high cost.

Accordingly, the demand site 400 may perform a DR method of reducing the demand during period A, in which the demand exceeds the supply, through demand reduction without facility expansion, as illustrated in FIG. 5.

In addition to this, the demand site 400 may perform a Plus DR method of using the supply in advance during period C, in which the energy supply exceeds the demand, as illustrated in FIG. 6.

As described above, when DR and Plus DR are used together in the process of supplying multi-energy resources, the demand is maintained constant over the entire time period, which may support stable operation of the energy production unit 110 supplying it.

Meanwhile, the demand site 400 may or may not include a storage unit for storing multiple forms of energy. When the demand site 400 includes a storage unit, the demand site 400 may support both DR and Plus DR. When the demand site 400 does not include a storage unit, the demand site 400 may support only DR.

For the energy production unit 110, supplying a constant amount of energy to the demand site 400 may be advantageous in terms of energy consumption or maintenance of the energy production equipment. Accordingly, the demand site 400 needs to be provided with the storage unit capable of storing multi-energy resources to ensure stable operation. The demand site 400 equipped with such a storage unit may perform plus DR, and the demand site 400 that perform plus DR may receive energy at a relatively lower cost.

The demand resource management system configured as described above may produce energies such as compressed air, hot water, and steam required by an industrial complex at one place (the main plant 100), and may connect and supply the produced energy to each of the demand sites 400 requiring it through the piping 200.

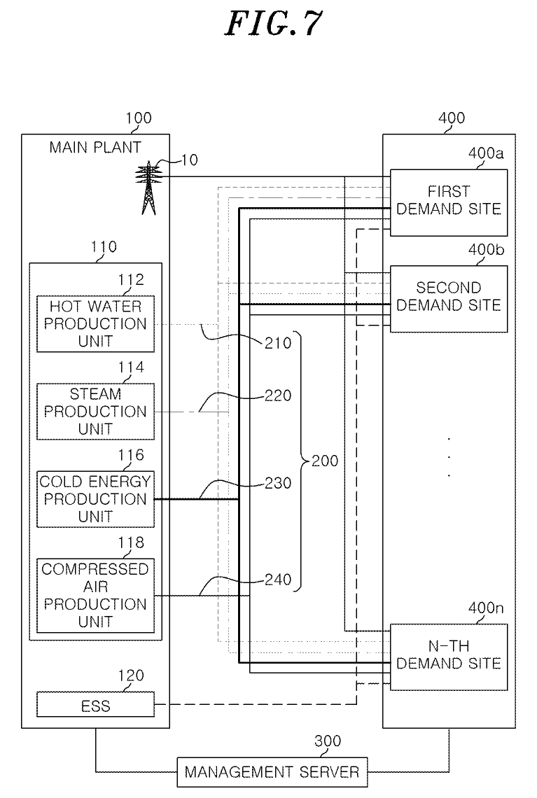

FIG. 7 is a diagram for describing a demand resource management system through a multi-energy network according to another embodiment of the present disclosure.

Referring to FIG. 7, a demand resource management system through a multi-energy network according to another embodiment of the present disclosure may include an energy production unit 110, an ESS (Energy Storage System) 120, piping 200, a management server 300, and a demand site 400.

The energy production unit 110, the management server 300, and the demand site 400 are the same as the energy production unit 110, the management server 300, and the demand site 400 illustrated in FIG. 2, so a description thereof will be omitted.

The ESS 120 is installed within the main plant 100 and may store electricity generated by renewable energy.

When electricity generated by renewable energy is stored in the ESS 120, the electricity stored in the ESS 120 may be resold without going through the electricity market. Therefore, when the ESS 120 producing electricity through renewable energy is installed in the main plant 100 equipped with an energy production unit for producing multiple energies, the main plant 100 may supply (sell) the electricity stored in the ESS 120 to the demand site 400 along with multiple energies such as steam, hot water, and compressed air.

Therefore, the management server 300 may supply the electricity stored in the ESS 120 to the demand site 400 according to a request from the demand site 400.

The piping 200 may connect each energy production unit 110 and each demand site 400 to deliver the energy produced in each energy production unit 110 to each of the plurality of demand sites 400. Furthermore, the piping 200 may connect the ESS 120 and each demand site 400 to deliver the electricity stored in the ESS 120 to each of the plurality of demand sites 400.

Therefore, the piping 200 may include hot water piping 210, steam piping 220, cold energy piping 230, compressed air piping 240, and a power line 250.

The hot water piping 210, the steam piping 220, the cold energy piping 230, and the compressed air piping 240 are the same as the hot water piping 210, the steam piping 220, the cold energy piping 230, and the compressed air piping 240 described in FIG. 2, so a description thereof will be omitted.

The power piping 250 may be an infrastructure for supplying the power (electricity) stored in the ESS 120 to the demand site 400. The power piping 250 may be implemented as, for example, an ELP (corrugated hard polyethylene) pipe or the like.

The demand resource management system configured as described above may produce not only energies such as compressed air, hot water, and steam required by an industrial complex, but also electricity at one place (the main plant 100), and may connect and supply the produced energy and electricity to each of the demand sites 400 requiring them through the piping 200. Therefore, the demand resource management system may enable DR (Demand Response) brokerage for electricity and multi-energy at the main plant 100, and thereby may enable more flexible energy utilization.

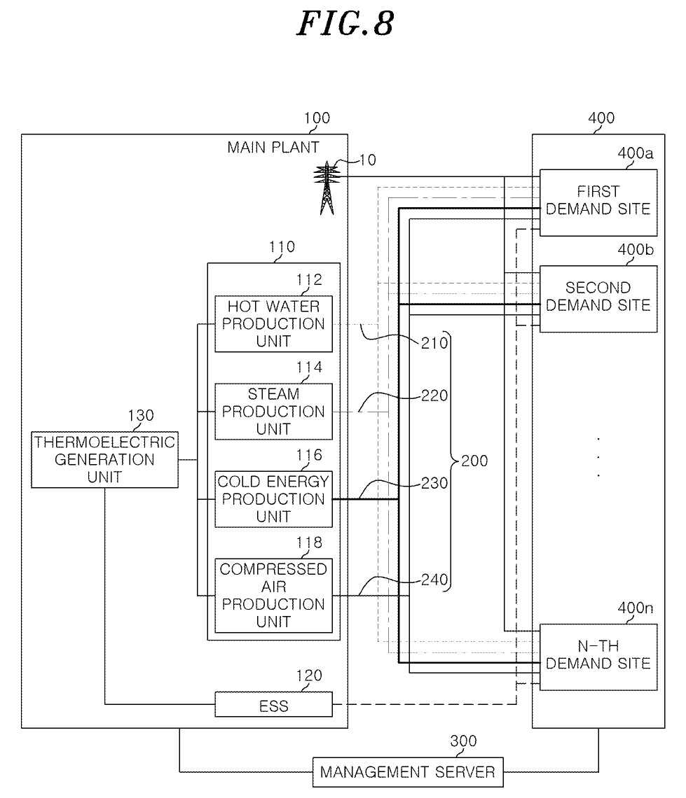

FIG. 8 is a diagram for describing a demand resource management system through a multi-energy network according to yet another embodiment of the present disclosure.

Referring to FIG. 8, a demand resource management system through a multi-energy network according to yet another embodiment of the present disclosure may include an energy production unit 110, an ESS 120, a thermoelectric generation unit 130, piping 200, a management server 300, and a demand site 400.

The energy production unit 110, the ESS 120, the piping 200, the management server 300, and the demand site 400 are the same as the energy production unit 110, the ESS 120, the piping 200, the management server 300, and the demand site 400 illustrated in FIG. 7, so a description thereof will be omitted.

The thermoelectric generation unit 130 is installed within the main plant 100, and may convert surplus energy, from among the energy produced by the energy production unit 110, not supplied to the demand site 400 into electrical energy and store it in the ESS 120.

Even if the energy production unit 110 produces energy corresponding to the type and amount of demand requested by the demand site 400, the production amount may be greater than the demand amount. In this case, the main plant 100 may use the thermoelectric generation unit 130 to convert the surplus energy not supplied to the demand site 400 into electrical energy. Since the energy left over without being consumed may be converted into electrical energy through waste heat recovery thermoelectric generation, the main plant 100 may enable efficient energy management.

As described above, according to one aspect of the present disclosure, an embodiment produces energy sources such as hot water, steam, and compressed air used in an industrial complex in one place and configures a network through piping (a pipeline), whereby energy may be shared through the piping, and thereby, the energy may be effectively provided to demand sites that require the energy.

According to one aspect of the present disclosure, for energies such as hot water, steam, and compressed air, a storage space for the corresponding energy source may be established at a lower cost compared to electricity, and through this, by applying various types of demand management (e.g., DR, Plus DR), the efficiency of the energy may be improved, and at the same time, the maintenance and performance of the energy production units may be improved by inducing operation of the energy production units at an optimal operating point.

The term "unit" used in this specification may include a unit implemented as hardware, software, or firmware, and may be used interchangeably with terms such as, for example, logic, a logic block, a component, or a circuit. A "unit" may be a component formed as a single body or a minimum unit of the component or a part thereof performing one or more functions. For example, according to an embodiment, a "unit" may be implemented in the form of an Application-Specific Integrated Circuit (ASIC).

The present disclosure has been described with reference to the embodiments shown in the drawings, but these are merely exemplary, and it will be understood by those skilled in the art that various modifications and other equivalent embodiments are possible therefrom.

Therefore, the true technical protection scope of the present disclosure should be determined by the patent claims below.

What is claimed is:

1. A demand resource management system through a multi-energy network, comprising:
a main plant including one or more energy production units each configured to produce at least one energy selected from a group essentially consisting of hot water, steam, cold energy, and compressed air;
piping connecting each of the one or more energy production units and each of a plurality of demand sites to deliver the at least one energy produced in each of the one or more energy production units to each of the plurality of demand sites; and
a management server configured to control the one or more energy production units and the piping so that energy corresponding to a type and an demand amount requested by each of the plurality of demand sites is supplied to the corresponding demand site.

2. The demand resource management system through the multi-energy network of claim 1, wherein the one or more energy production units comprise:
a hot water production unit for producing the hot water;
a steam production unit for producing the steam;
a cold energy production unit for producing the cold energy; and
a compressed air production unit for producing the compressed air.

3. The demand resource management system through the multi-energy network of claim 2, wherein the piping comprises:
hot water piping connecting the hot water production unit to each of the plurality of demand sites, respectively;
steam piping connecting the steam production unit to each of the plurality of demand sites, respectively;
cold energy piping connecting the cold energy production unit to each of the plurality of demand sites, respectively; and
compressed air piping connecting the compressed air production unit to each of the plurality of demand sites, respectively.

4. The demand resource management system through the multi-energy network of claim 3, wherein the main plant further comprises an energy storage system for storing electricity produced by renewable energy.

5. The demand resource management system through the multi-energy network of claim 4, wherein the piping further comprises power piping connecting the energy storage system to each of the plurality of demand sites, respectively, to supply the electricity stored in the energy storage system to each of the plurality of demand sites.

6. The demand resource management system through the multi-energy network of claim 4, wherein the main plant further comprises a thermoelectric generation unit converting surplus energy, from the energy produced by the one or more energy production units, not supplied to the plurality of demand sites into electrical energy and storing the electrical energy in the energy storage system.

7. The demand resource management system through the multi-energy network of claim 1, wherein the main plant further comprises a measuring device generating information about an amount of energy produced and an amount of energy supplied by each of the one or more energy production units and transmitting the information to the management server.

8. The demand resource management system through the multi-energy network of claim 1, wherein the management server is configured to control the one or more energy production units to produce energy corresponding to the type and the amount of demand requested by each of the plurality of demand sites.

9. The demand resource management system through the multi-energy network of claim 1, wherein each of the plurality of demand sites, when a storage unit for storing the energy supplied through the piping is provided, performs demand management to reduce the demand amount during a time interval when a demand for the energy exceeds a supply amount of the energy, and performs the demand management to receive an additional supply of the energy by an amount corresponding to the reduced demand amount when the supply amount of the energy exceeds the demand amount of the energy.

10. The demand resource management system through the multi-energy network of claim 1, wherein the demand site, when a storage unit for storing the energy supplied through the piping is not provided, performs demand management to reduce the demand amount during a time interval when the demand amount of the energy exceeds a supply amount of the energy.

11. A demand resource management system through a multi-energy network, comprising:
a main plant arranged to produce at least one energy selected from a group essentially consisting of hot water, steam, cold energy, and compressed air;
a plurality of demand sites for receiving and consuming the at least one energy produced in the main plant;
piping connecting each energy source and each of the plurality of demand sites to deliver the at least one energy produced in the main plant to each of the plurality of demand sites; and
a management server configured to control the piping so that energy corresponding to a type and an amount of demand requested by each of the plurality of demand sites is supplied to the corresponding demand site.

12. The demand resource management system through the multi-energy network of claim 11, wherein the main plant comprises an energy production unit including at least one of a hot water production unit for producing the hot water; a steam production unit for producing the steam; and a cold energy production unit for producing the cold energy, and a compressed air production unit for producing the compressed air.

13. The demand resource management system through the multi-energy network of claim 12, wherein the main plant further comprises an energy storage system for storing electricity produced by renewable energy.

14. The demand resource management system through the multi-energy network of claim 13, wherein the main plant further comprises a thermoelectric generation unit for converting surplus energy, from the energy produced by the energy production unit, not supplied to the plurality of demand sites into electrical energy and storing the electrical energy in the energy storage system.

15. The demand resource management system through the multi-energy network of claim 12, wherein the main plant further comprises a measuring device for generating information about an amount of energy produced and an amount of energy supplied by the energy production unit and transmitting the information to the management server.

16. The demand resource management system through the multi-energy network of claim 12, wherein the piping comprises different piping installed according to a type of the energy produced by the energy production unit.

17. The demand resource management system through the multi-energy network of claim 16, wherein the piping comprises:
hot water piping connecting the hot water production unit to each of the plurality of demand sites, respectively;
steam piping connecting the steam production unit to each of the plurality of demand sites, respectively;
cold energy piping connecting the cold energy production unit to each of the plurality of demand sites, respectively; and
compressed air piping connecting the compressed air production unit to each of the plurality of demand sites, respectively.

18. The demand resource management system through the multi-energy network of claim 11, wherein the plurality of demand sites are configured to perform at least one of DR (Demand Response) and Plus DR based on a demand for the energy and a supply amount received through the piping.

19. The demand resource management system through the multi-energy network of claim 18, wherein each of the plurality of demand sites, when a storage unit for storing the energy supplied through the piping is provided, performs demand management to reduce the demand amount during a time interval when a demand for the energy exceeds a supply amount of the energy, and performs the demand management to receive an additional supply of the energy by an amount corresponding to the reduced demand amount when the supply amount of the energy exceeds the demand amount of the energy.
